(19) United States
(12) Patent Application Publication
(10) Pub. No.: US 2022/0231633 A1
(43) Pub. Date: Jul. 21, 2022

(54) DYNAMIC SUPPORT STRUCTURE FOR SOLAR PANELS

(71) Applicant: Axet S.r.l., Casale sul Sile, TV (IT)

(72) Inventors: Manuele CAVALLI, Casale sul Sile, TV (IT); Tommaso CAVALLI, Casale sul Sile, TV (IT)

(73) Assignee: Axet S.r.l., Casale sul Sile, TV (IT)

(21) Appl. No.: 17/617,041

(22) PCT Filed: May 13, 2020
(86) PCT No.: PCT/IT2020/050117

§ 371 Date: Dec. 7, 2021

(30) Foreign Application Priority Data
Jun. 7, 2019 (IT) 102019000008322

(51) Int. Cl. H02S 20/32; F24S 30/452; F24S 20/70

(52) U.S. Cl. CPC H02S 20/32; F24S 2030/14; F24S 20/70; F24S 30/452

(57) ABSTRACT

A support structure for solar panels (100), comprising at least one solar panel (100) placed above a water basin and connected to a piston (1), which is fixed to the bottom at the water basin. The piston (1) is connected, on the side opposite to the bottom of the basin, to the solar panel (100) by means of a support bar or stem (10), which protrudes from the piston (1) and has first terminal elements (11) constrained to slide in respective side guides (20) of the solar panel (100). The solar panel (100) is hinged, at a lower edge (23), to a frame (9) which is integral with a hollow cylinder (3) installed about the piston (1) and slidably constrained to the piston (1) by second terminal elements (7) connected to the cylinder (3). The cylinder (3) consists of a float tank that can be filled or emptied at least partially with liquid or fluid means by pumping means (4) so that it can gradually move from a position of immersion, where the cylinder (3) is at least partially filled and rests on the bottom of the water basin, to a position of emersion, where the cylinder (3) is at least partially emptied and floats at a surface level (G) of the water basin.

The present invention concerns a dynamic support structure for solar panels; more particularly, the invention is related to a floating-type support structure on several axes, for photovoltaic and/or thermal solar panels and specifically, the panels can be installed on an element of the structure able to float on sheets of water, such as reservoirs and/or artificial or natural water basins, lakes or seas.

It should be noted that a solar panel can be understood as a solar thermal panel adapted to heat a fluid within a heating or domestic water production system, a solar concentration panel adapted to heat a fluid to generate electricity with a turbo-alternator, a photovoltaic solar panel composed of photovoltaic cells, which directly converts solar energy into electricity by exploiting the photovoltaic effect, or a hybrid solar panel, adapted to create a photovoltaic co-generation by coupling a solar thermal panel with a solar photovoltaic panel.

The floating solar panels of known type have a structure substantially equivalent to their analogous ones installed on land as far as the module used for the collection of solar radiation is concerned.

Unlike the latter, traditional floating solar panels are equipped with support structures fixed to bodies, usually made of polymeric materials, able to float on the water surface, thus supporting the weight of the panel.

It is well known that floating solar panels have a number of advantages over their equivalents installed on land, such as for example:
reduced environmental impact, due to the zero ground use that their installation requires;
better energy efficiency and longer average life due to the lower operating temperatures at which the panels work;
low maintenance costs due to the lower accumulation of dust on their surface;
ease of implementation of solar tracking systems.

However, the current solar tracking technology that can be implemented on floating installations has some significant drawbacks.

In fact, there are well-known solar tracking systems which involve mounting several panels on a first mobile frame placed on a second fixed frame, which in turn is anchored at the bottom of the body of water or on land.

The mobile frame is set in motion by appropriate mechanical means, for example by means of tracks and/or gear wheels, thus causing the panels to change orientation along the azimuth plane.

The solar panels can have a fixed inclination along the vertical plane (elevation or “tilt”), or they can provide solar tracking systems also along this direction, with a consequent increase of the system complexity.

It is clear that the presence of multiple mechanical parts is already in itself a risk factor from the point of view of failures and/or malfunctions in general.

In addition, current solar tracking technologies rely on electrical and/or electronic sensors, which are known to have a relatively low reliability compared to mechanical components.

In addition, it is known that in order to improve the performance of solar panels, in addition to providing floating solar panels and intervening on the position of the solar panel with respect to the sun by means of solar trackers, it would be convenient to obtain a reduction in the energy used to implement the above-mentioned tracking, as well as a reduction in the working temperature of the individual panel, while also continuously checking the operating status and efficiency of the panel.

It is clear, therefore, that there is a need for an alternative solution to the known technique, especially with respect to solar tracking technologies (which are complex and expensive both from a financial and energetic viewpoint) and to the systems for monitoring the efficiency and proper functioning of the floating solar panels currently available.

The aim of this invention is therefore to overcome the drawbacks of the known art mentioned above and in particular, to provide a support structure for solar panels which ensures maintaining the best conditions of solar panel pointing with respect to the apparent movement of the sun, in a reliable, efficient, simple and economic way as compared to the advantages achieved.

In particular, low-consumption biaxial solar tracking is carried out, ensuring the best conditions of the panel pointing are maintained with respect to the apparent movement of the sun.

Another aim of the invention is to create a support structure for solar panels, which guarantees effective cooling of the solar panel and is able to operate safely and reliably even in particularly unfavourable environments and/or in the presence of humidity, dust and high temperatures and/or natural disturbing forces, such as wind and wave motion.

A further aim of the invention is to provide a support structure for solar panels, which allows an effective verification of the functionality and efficiency of the individual panels (deduced from the operating temperature).

Last but not least, the aim of the invention is to create a support structure for solar panels, which is simple to build and use, as well as having low installation and maintenance costs as compared to the advantages achieved.

These and other aims are achieved by a support structure for solar panels according to the attached claim 1; further features and details of the support structure for solar panels according to this invention are given in the following dependent claims.

The present invention will now be described, by way of non-limiting example, according to some of its preferred embodiments, with reference to the attached figures, wherein:

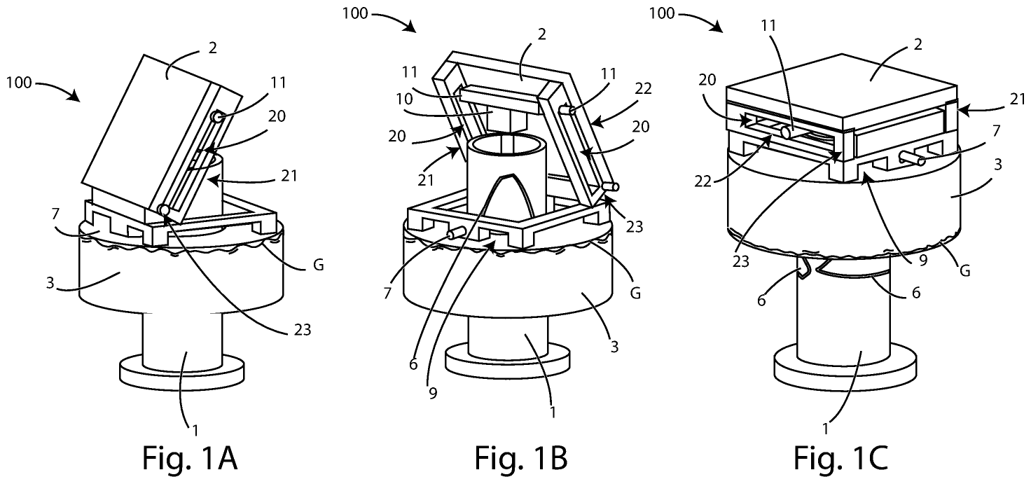

FIGS. 1A, 1B and 1C show frames related to simplified perspective views of a dynamic support structure for solar panels, according to the invention, in which the panel is depicted oriented in three different directions, along the azimuth plane and along the elevation plane, corresponding to three different moments of the day (the movement is actually continuous over 12 hours);

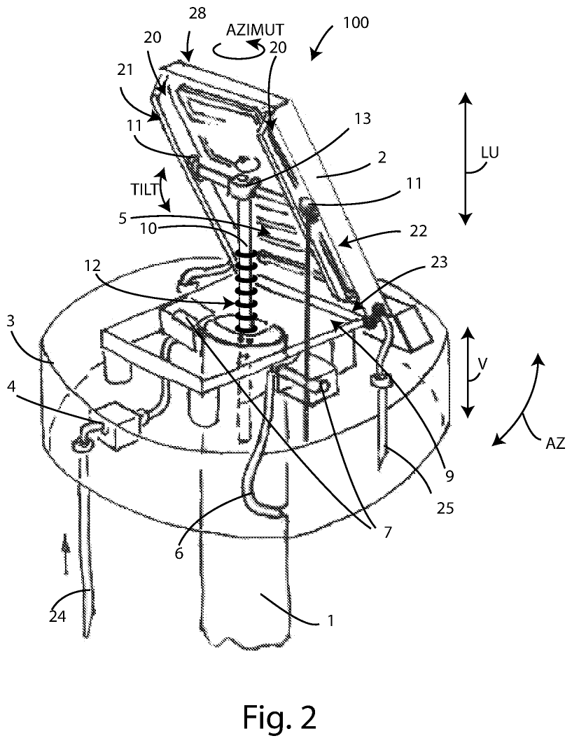

FIG. 2 shows a schematic representation of a preferred embodiment of the support structure for solar panels according to the present invention;

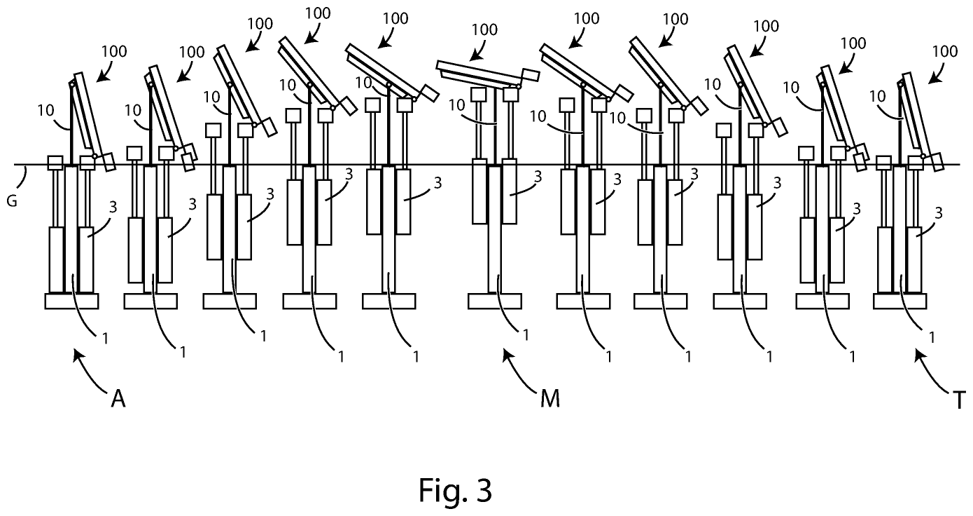

FIG. 3 shows a series of successive elevation positions of the solar panel ensured by the dynamic support structure according to the invention, during an entire day;

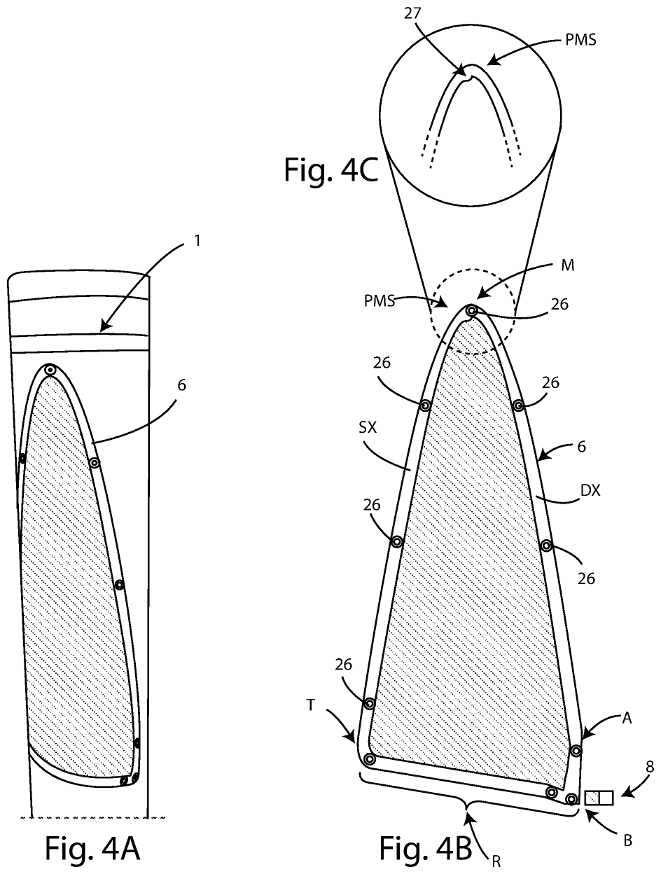

FIGS. 4A and 4B show two schematic detail views of the dynamic support structure guidance system for solar panels according to the invention;

FIG. 4C shows an enlarged detail of FIG. 4B, according to the invention.

With reference to the figures mentioned, the support structure for solar panels according to the present invention includes a support pillar or piston 1, which is anchored at the bottom of a body of water and which, at the top, allows fixing to a structure constrained to the solar panel 100, at a surface level G of the body of water.

The pillars or pistons 1 can be of various heights if a series of solar panels 100 are installed, in order to avoid mutual interference between the panels 100 and optimize solar radiation.

Inside piston 1 there is a support bar or stem 10, e.g. a metal or polymeric bar or stem, which is preferably T-shaped, and consisting of sliders 11 with respective bearings 26, which are preferably placed on the first ends of the horizontal section of the T.

The bearings 26 of the sliders 11 are inserted and free to slide in guides or rails 20 obtained on the right and left side edges 21, 22 of the support structure for the solar panel 100 to allow the “tilt” movement.

The support bar 10, which is adapted to define the amount of variation in the tilt angle (elevation) of the solar panel 100, can have a central joint 13, which also allows the azimuth rotation (about 180°) of the panel 100.

In addition, bar 10 is adjustable in its portion coming out from piston 1, by means of appropriate adjustment means 12, such as relief notches, which make it possible to vary the maximum elevation of the panel 100 according to the seasons (height of the sun on the horizon).

In fact, the useful length LU of bar 10 can be modified according to the reference season in order to determine the width of the “tilt” angle of the panel 100, which changes according to the seasons, the azimuth rotation being equal, and the reference notches, preferably 12 in number, allow the bar 10 to re-enter the piston 1, thus reducing the measurement of the length LU for 12 different levels.

Below the solar panel 100 and around the piston 1, there is a cylinder 3, which can consist of a hollow float tank of various shapes and sizes (variable according to the spaces and weight of the entire support structure of the panel 100) and preferably shaped like a donut or toroid to provide less resistance to movement; the cylinder 3 can be filled and emptied with water or other liquid or fluid medium, thus generating a vertical movement from bottom to top (emptying) and from top to bottom (filling).

Given that the lower edge 23 of the panel 100 is hinged on its lower side to a frame 9 integral with cylinder 3, this movement generates a variation of the tilt angle, thus continuously changing its inclination.

In this way, simply by filling the cylinder 3, it is possible to modify the elevation or tilt of the panel 100, since panel 100 itself is constrained to rotate about the hinge of the lower edge 23 and to slide along the prismatic couplings provided at the side edges 21, 22, which include the guides 20 and the respective sliders 11 with relative bearings 26.

Cylinder 3 can be filled and emptied by means of a bidirectional electric pump 4 or by means of an inlet or loading pump and an outlet or discharge pump.

In a preferred variant of the invention, before being conveyed into cylinder 3 or during the above mentioned conveying step, the water can be conducted, by means of appropriate valves, into special serpentine pipes 5, preferably made of carbon, placed behind the solar panel 100, in order to lower the operating temperature of panel 100 and improve its efficiency.

In order to maximize this cooling action, water can be drawn through a drawing pipe 24 deep from the installation site of the support structure in order to obtain a stabilized thermal regime of the liquid on average over the season.

The liquid passing through the carbon serpentine pipes 5 can also be sprayed, in part and through a series of nozzles 28, from the upper portion of panel 100 onto the front of the panel 100 itself for better total cooling; the water is in continuous circulation and can keep the whole structure at 25° C., a temperature that allows the best efficiency of panel 100.

With reference to FIG. 3, showing in detail an example of a variation in the elevation of the solar panel 100 during the day, the filling level of cylinder 3 as a function of the apparent position of the sun, is shown.

In particular, at dawn (position A) and sunset (position T), when the apparent motion of the sun causes the elevation of the sun in the sky to be minimal, cylinder 3 is completely filled with water and reaches the lowest positions with respect to the surface level G of the surrounding body of water; in these positions, the overall action of piston 1 and of the sliders 11 of stem 10 on the lower edge 23 and guides 20 of panel 100 causes the positioning of panel 100 in a configuration of maximum inclination, which is optimal for capturing the radiation of the sun that is low on the horizon.

As time goes by, between the extreme positions of dawn A and sunset T, the apparent motion of the sun first causes it to rise on the horizon, starting from position A corresponding to dawn, up to a maximum position (position M corresponding to midday), and then its lowering on the horizon line (from position M corresponding to midday to position T corresponding to sunset) and therefore, during these phases, the inclination of the solar panel 100 must necessarily decrease.

For this purpose, cylinder 3 is progressively emptied of the water inside it by means of pump 4 until its buoyancy force brings it closer to level G of the free surface of the body of water in which it is immersed.

Thus, a progressive and gradual decrease in the inclination of panel 100 is obtained between positions A, M and T, M, while in position M corresponding to midday, when the elevation of the sun is maximum, the height of cylinder 3, now empty, reaches the surface level G and the inclination of panel 100 is minimal or zero.

The cycle is reversed between the position M corresponding to midday and the position T corresponding to sunset T; cylinder 3 is filled again gradually and the inclination of the panel 100 increases to a maximum value, while cylinder 3 is in the lowest position.

The above-mentioned steps of filling and gradually emptying cylinder 3 are programmable remotely depending on the position (latitude and longitude) where the support structure is installed, and these steps can be activated automatically for optimal operation of the structure throughout the day.

The whole movement lasts for about 12 hours (from dawn to sunset), so the electric bidirectional pump 4 (or the loading and discharge pumps, in case they are present instead of the bidirectional pump) can have low power as it does not act directly on the mechanical action necessary to favour the movement of cylinder 3, rather it induces such action thanks to the hydrostatic thrust that receives the aforesaid cylinder 3; the water movement is continuous over 12 hours, since it starts from the full cylinder 3 completely immersed in water and, afterwards, pump 4 allows it first to be emptied (in the first 6 hours) and then to be filled again (in the following 6 hours), thanks to the activation of the water loading from the inlet pipe 24 and the water discharge from the outlet pipe 25; this activation is controlled by a sensor adapted to detect the position of cylinder 3 with respect to piston 1.

In addition, preferably throughout the day, the water flow circulated is also sent into the cooling serpentine 5 installed below the solar panel 100 and/or to the surface irrigation system on the top of the panel 100 made by the nozzles 28.

In an advantageous way, in case of strong wind or adverse weather conditions, an electrically-operated valve opens a large discharge duct, which generates the quick emptying of the cylinder 3, as well as a quick raising of the cylinder 3 itself, and therefore the safe horizontal positioning of the solar panel 100.

With particular reference to FIGS. 4A and 4B, a further characteristic of the present invention is the presence, on the surface of piston 1, of at least one shaped groove 6, which acts as a guide for the rotary movement of cylinder 3.

At least one second terminal element or pin 7 is constrained to slide in such groove 6 and in particular, two opposite pins 7, which are fixed to the support frame 9 of the solar panel 100 and are arranged in a direction perpendicular to piston 1.

The pins 7 allow guiding the movement of cylinder 3, which is moved by the hydrodynamic thrust generated by its filling or emptying, not only in the vertical direction V, but also in the azimuth direction AZ.

The pins 7 can be fitted with airtight ball bearings to facilitate movement.

Therefore, together with the continuous tilt movement, which modifies the inclination of panel 100 by means of the vertical direction movement V of cylinder 3, cylinder 3 itself, whose pins 7 slide in the respective grooves 6 obtained on the outer surface of piston 1, also imparts a rotary azimuth movement to panel 100, about an axis perpendicular to the support surface of piston 1.

In particular, the shaping of groove 6 forces piston 1, which is pushed upwards (direction obtained thanks to the hydrostatic thrust determined by the emptying of cylinder 3), to rotate by an azimuth angle of about 180° about the axis of piston 1.

FIG. 4B shows a front view of groove 6, which has a closed shape that reconstructs the apparent movement of the sun on the horizon.

The position at the beginning of the cycle of each pin 7 on the respective groove 6 (indicated with A) is the initial position of the structure corresponding to dawn (with solar panel 100 forming a “tilt” angle of about 80°, at latitudes of Italy, with respect to the horizontal surface of frame 9 and the surface level G); the intermediate position M is the position corresponding to midday (with solar panel 100 forming a “tilt” angle of about 20°, at latitudes of Italy, with respect to level G), while the position T, placed at the same height as position A, is the position at the end of the cycle corresponding to sunset (with solar panel 100 forming a “tilt” angle of about 80°, at latitudes of Italy, with respect to level G).

The above positions correspond to the positions shown in FIG. 3.

Therefore, in addition to the tilting motion of panel 100 with respect to the horizontal direction and combined with this, the movement of each pin 7 is guided by groove 6 and replicates a closed cyclic path in order to obtain an angular movement of panel 100 in the azimuth direction during the period of about 12 hours from dawn to sunset.

After sunset, each pin 7 is brought back by gravity along section R on the closed path, in a fixed rest position B, ensured by the presence of a magnet 8, which forces bearing 26, placed at the end of pin 7, to move back to position A at the beginning of the cycle, corresponding to dawn, the next morning. The magnet 8 ensures that the travel starts from the correct position and that the pin 7, with its bearing 26, always travels the initial upward direction DX.

In addition, in the intermediate position M, the curve advantageously follows a particular “non-return” deformation so that once the maximum emptying, and therefore the maximum height generated by the emptying of tank 3, has been reached, the pins 7 with their bearings 26 pass an upper dead point PMS and are positioned in a small cavity 27 immediately following this point; in this way, the descent can only continue on the descending side SX of the groove 6 towards the position T.

In an advantageous way, in fact, two grooves 6 are obtained on the surface of piston 1, in opposite positions, in which just as many pins 7 slide that end with suitable bearings 26 to facilitate the movement.

Moreover, unlike traditional checks of the operating status and efficiency of each solar panel 100 (usually obtained with electrical power measurements, with measurements of the energy generated or with monitoring systems through drones, which, through a thermographic analysis, detect thermal anomalies related to malfunctions), according to the present invention, it is possible to use bi-adhesive tapes sensorized with thermostats, which show anomalous temperatures by providing the X, Y coordinates of the defective panel remotely and in real time.

It is evident from what has been described how the present invention exploits the weight loss of the entire support structure on which the solar panel is fixed, thanks to the floating thereof on water obtained by fixing it to the cylinder or tank.

In addition, the support structure in question exploits the hydrostatic thrust and the particularly slow management of the solar tracking phenomenon using the hydrostatic action as reducer of the energy required for movement.

Finally, it is possible to use the water circulation in certain jet (nozzle) and/or serpentine pipes located above and behind the panel to cool the panel.

It is estimated that an increase in energy efficiency of more than 40% compared to a traditional panel is obtained thanks to the combined use of the technical characteristics listed above.

Also, depending on the context in which the solar panels are used, in the case of hybrid panel systems, the installation may be envisaged of additional panel outlet pipes for heating water for use in domestic and/or industrial buildings.

Finally, it is obvious that a series of solar panels 100 can be installed as part of a single system, each one connected to its own support structure made according to the invention; moreover, each support structure can be connected to one or more modules 2 that make up each solar panel 100.

The characteristics of the support structure for solar panels the object of this invention clearly emerge from the description, as do the advantages thereof.

In particular, these advantages include the following aspects:
“tilt” solar tracking with continuous variation;
azimuth solar tracking with continuous variation;
continuous cooling of the panel;
minimizing the energy required to move the panel for solar tracking;
installation simplicity and robustness, brought about by the fixing at the bottom;
immunity, therefore, to possible wave motion of the water surface;
safety mode in case of strong wind and difficult weather conditions;
punctual verification of the operating status of the panel;
specific geometric arrangement of various panels to avoid mutual interference with solar radiation.

Finally, it is apparent that although this invention is described by way of example only, without limiting the scope of application thereof, according to its preferred embodiments, it shall be understood that the invention may be modified and/or adapted by experts in the field without thereby departing from the scope of the inventive concept, as defined in the claims herein.

1. Dynamic support structure for solar panels (100), comprising at least one solar panel (100) placed above a water basin and connected to a piston (1), said piston (1) being fixed to the bottom of said water basin and being connected, on the opposite side with respect to the bottom of the basin, to said at least one solar panel (100) by means of a support bar or stem (10), which comes out from said piston (1) and which has first terminal elements (11) constrained to slide inside respective side guides (20) of said solar panel (100), characterized in that said solar panel (100) is hinged, at a lower edge (23), to a frame (9) integral with a hollow cylinder (3), said cylinder (3) being positioned around said piston (1) and being slidably constrained to said piston (1) through second terminal elements (7) connected to said cylinder (3), said cylinder (3) also being constituted by a float tank that can be filled or emptied at least partially with liquid or fluid means through pumping means (4), so as to be able to pass gradually from an immersion position, according to which said cylinder (3) is filled at least partially with said liquid or fluid means, to an emersion position, according to which said cylinder (3) is emptied at least partially of said liquid or fluid means and floats at a surface level (G) of said water basin.

2. Support structure as claimed in claim 1, characterized in that said support bar or stem (10) is adjustable through adjustment means (12), such as raised notches, which are provided in a portion (LU) of said stem (10) protruding from the piston (1), so as to determine the excursion of the maximum and minimum inclinations of said solar panel (100).

3. Support structure as claimed in claim 1, characterized in that said pumping means (4) include bi-directional electric-type pumping means or comprise an inlet or load pump and an outlet or discharge pump.

4. Support structure as claimed in claim 1, characterized in that said pumping means (4) send said fluid or liquid means through suitable nozzles (28) and/or serpentine pipes (5), said nozzles (28) and/or pipes (5) being positioned above and/or behind said solar panel (100).

5. Support structure according to claim 1, characterized in that said immersion position of said cylinder (3) is reached at dawn (A) and at sunset (T) and corresponds to a maximum inclination of said panel solar (100) with respect to said surface level (G) and with respect to the horizon, while said emersion position of said cylinder (3) is reached at midday (M) when the elevation of the sun is maximum and said solar panel (100) has a minimum or no inclination with respect to said surface level (G) and to the horizon.

6. Support structure as claimed in claim 1, characterized in that a predetermined discharge duct for discharging said liquid or fluid means out from said cylinder (3) is opened on command by means of a valve, in order to quickly discharge said cylinder (3) and cause it to rise towards said surface level (G), thus reaching an horizontal safety positioning of the solar panel (100) when strong wind and/or general adverse weather conditions occur.

7. Support structure according to claim 1, characterized in that said piston (1) has at least one shaped groove (6) provided on an outer surface of the piston (1) and said second terminal elements (7), which are arranged in a direction perpendicular to said outer surface of the piston (1), slide on said shaped groove (6), so as to guide the movement of the solar panel (100) according to a combined movement on two axes by continuously modifying the azimuth angle and the angle of inclination or tilt around the axis of said piston (1) during a movement in a vertical direction (V) of said cylinder (3).

8. Support structure as claimed in claim 7, characterized in that said at least one shaped groove (6) has a geometrical conformation as a closed curve and each of said second terminal elements (7) completes a closed path starting from an initial position (A) corresponding to dawn at an intermediate position (M) corresponding to the midday and up to a final position (T) corresponding to sunset, each of said second terminal elements (7) being forced to remain in a rest position (B) by means of a magnet (8), so that each second terminal element (7) moves from said rest position (B) to said initial position (A) and afterwards performs a new closed path on said closed curve.

9. Support structure according to claim 1, characterized in that bi-adhesive tapes with thermostats are used so as to signal anomalous temperatures of each solar panel (100).

10. Support structure as claimed in claim 1, characterized in that a plurality of solar panels (100) are connected to respective pistons (1) and said pistons (1) have various heights to avoid mutual interference between the solar panels (100) during solar radiation.
